(19) United States
(12) Patent Application Publication
(10) Pub. No.: US 2010/0083840 A1
(43) Pub. Date: Apr. 8, 2010

(54) INFUSIBLE SUBSTANCE DISPENSER

(76) Inventor: Robert Small, Park City, UT (US)

Correspondence Address: KARL R CANNON, PO BOX 1909, SANDY, UT, 84091, US

(21) Appl. No.: 12/257,388

(22) Filed: Oct. 23, 2008

Related U.S. Application Data
(63) Continuation-in-part of application No. 12/136,019, filed on Jun. 9, 2008, now abandoned.
(60) Provisional application No. 60/933,811, filed on Jun. 8, 2007.

(51) Int. Cl. A47J 31/44

(52) U.S. Cl. 99/279

(57) ABSTRACT

A device for dispensing an infusible substance, and a method for using the device are disclosed. The device may include a bag for holding the infusible substance. A cord may be attached to the bag for manipulating the bag. The bag and cord may be sealed in a pouch to maintain the infusible substance fresh. The device may be used by opening an upper portion and a lower portion of the pouch such that the cord extends out the top and the bag extends below the pouch. The bag may be placed in a liquid to dispense the infusible substance. The bag may then be drawn into the pouch with the cord and the pouch may be squeezed to compress excess fluid out of the bag. The bag may be discarded inside the pouch to further enhance the cleanliness of the dispensing procedure.

### CROSS-REFERENCE TO RELATED APPLICATIONS

This application is a continuation-in-part of co-pending U.S. patent application Ser. No. 12/136,019, filed Jun. 9, 2008, entitled “INFUSIBLE SUBSTANCE DISPENSER,” which claims the benefit of U.S. Provisional Application No. 60/933,811, filed Jun. 8, 2007, both of which are hereby incorporated by reference herein in their entireties, including but not limited to those portions that specifically appear hereinafter, the incorporation by reference being made with the following exception: In the event that any portion of the above-referenced applications are inconsistent with this application, this application supercedes said above-referenced applications.

### STATEMENT REGARDING FEDERALLY SPONSORED RESEARCH OR DEVELOPMENT

Not Applicable.

### BACKGROUND

1. The Field of the Invention

The disclosure relates generally to dispenser devices and methods, and more particularly, but not necessarily entirely, to devices and methods for dispensing infusible substances, such as tea, in a clean manner.

2. Description of Related Art

Dispensers for infusible substances, such as tea, have been made publicly available. Such dispensers commonly include a permeable bag containing the infusible substance. The bag is commonly placed in a fluid, such as hot water, to soak the infusible substance in the fluid and to extract soluble elements and flavor from the substance into the fluid. After the bag has been soaked in the fluid for a suitable time, the bag may be removed from the fluid with a string attached to the bag. This process often leaves excess fluid in the bag that often drips and creates a mess as the bag is withdrawn from the fluid, such as a cup of hot water.

One prior art attempt to overcome the problems with messy tea bags is disclosed in International Patent Application No. PCT/US95/08231, filed on Jul. 12, 1995 by Milone. Milone discloses a tea bag package that includes an envelope having a sealed bottom and a removable tab connected by a string to a tea bag housed in the envelope. The bottom of the envelope may be opened to allow the tea bag to fall out into a container with hot liquid. After infusion, the tab is removed from the envelope and the tea bag is drawn back into the envelope by pulling the tab upward so that the unsightly used tea bag is hidden from view and so that excess liquid can be squeezed from the tea bag by pressing the sides of the envelope together. While Milone's device is an improvement over using traditional tea bags, in practice the Milone device appears somewhat unsatisfactory for its intended purpose. In particular, the use of a single string between the tab and the tea bag permits the tea bag to freely rotate as the tea bag is withdrawn from the container. This free rotation may allow the tea bag to drip and create a mess if not carefully handled. Further, the free rotation of the tea bag after it has been removed from the container causes the tea bag to become misaligned with the opening in the bottom of the envelope such that pulling on the tab causes the tea bag to potentially jam crosswise against the envelope opening. Often times, the tea bag must be dislodged and reoriented to the correct position by hand or some other means such that it can be withdrawn into the envelope. It would therefore be an improvement over the prior art to provide a tea bag dispenser that has a guiding feature for allowing the tea bag to be more easily withdrawn into the envelope and to reduce the occurrences of the tea bag becoming lodged against the envelope.

Another drawback to the previously available tea bag packages is that they allow excessive heat to pass to the outer surface of the package such that a user's fingers may be burned while squeezing out excess liquid from the tea bag. It would therefore be an improvement to provide a means for inhibiting heat from passing to an outer surface of the packaging material.

Thus, despite the advantages of known devices and methods for dispensing infusible substances, improvements are still being sought. The publicly available products are characterized by several disadvantages that are addressed by the disclosure. The disclosure minimizes, and in some aspects eliminates, the above-mentioned failures, and other problems, by utilizing the methods and structural features described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a schematic side perspective view of a device for dispensing an infusible substance, including a pouch and a bag;

FIG. 2 is a schematic side perspective view of the device of FIG. 1 as upper and lower portions of the pouch are being removed;

FIG. 3 is a schematic side perspective view of the device of FIG. 1, with the upper and lower portions of the pouch removed and the bag extending beneath the pouch;

FIG. 3A is a schematic side perspective view of one embodiment of a device for dispensing an infusible substance, including a pouch and a bag, with upper and lower portions of the pouch removed and the bag extending beneath the pouch;

FIG. 3B is a cross-section view of the pouch shown in FIG. 3A along the section lines A-A;

FIG. 4 is a schematic side perspective view of the bag of FIG. 1 in a cup and the pouch extending outside of the cup;

FIG. 5 is a schematic side perspective view of one embodiment of a device for dispensing an infusible substance, including a pouch and a bag, with upper and lower portions of the pouch removed and the bag extending beneath the pouch;

FIG. 6 is a schematic side perspective view of one embodiment of a device for dispensing an infusible substance, including a pouch and a bag, with upper and lower portions of the pouch removed and the bag extending beneath the pouch;

FIG. 7 is a schematic side perspective view of one embodiment of a device for dispensing an infusible substance, including a pouch and a bag, with upper and lower portions of the pouch removed and the bag extending beneath the pouch;

FIG. 8 is a schematic side perspective view of one embodiment of a device for dispensing an infusible substance;

FIG. 9 is a schematic side perspective view of one embodiment of a device for dispensing an infusible substance, including a pouch and a bag, with upper and lower portions of the pouch removed and the bag extending beneath the pouch;

FIG. 10 is a schematic side perspective view of one embodiment of a device for dispensing an infusible substance, including a pouch and a bag, with upper and lower portions of the pouch removed and the bag extending beneath the pouch;

FIG. 11 is a schematic side perspective view of one embodiment of a device for dispensing an infusible substance, including a pouch and a bag, with upper and lower portions of the pouch removed and the bag extending beneath the pouch;

FIGS. 12A-12C depict a method of withdrawing a tea bag into a pouch in accordance with an embodiment of the present disclosure;

FIG. 13A-13C depict an alternative embodiment of a device for dispensing an infusible substance, including a pouch with ends that are not sealed, and a bag; and

FIG. 14A-14C depict another alternative embodiment of a device for dispensing an infusible substance, including a pouch having a tear-out portion, and a bag.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the compositions and methods for dispensing infusible substances are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

It must be noted that, as used in this specification and the appended claims, the singular forms “a,” “an,” and “the” include plural referents unless the context clearly dictates otherwise. Moreover as used herein, the terms “comprising,” “including,” “containing,” “characterized by,” and grammatical equivalents thereof are inclusive or open-ended terms that do not exclude additional, unrecited elements or method steps.

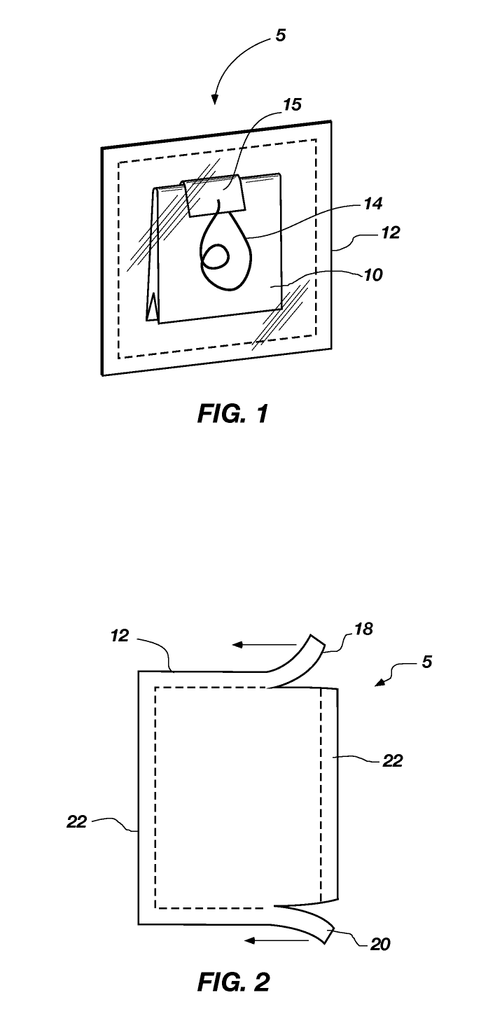

Referring now to FIG. 1, a schematic side perspective view is shown of an embodiment of a dispensing device, indicated generally at 5, for dispensing an infusible substance. It will be understood that the infusible substance may be any known material or composition, such as tea, for infusing into another material or composition, such as water. It will be appreciated that the principles of the disclosure may be used with any suitable material known in the art.

The dispensing device 5 may include a bag 10 for containing the infusible substance. The bag 10 may be permeable to water similar to tea bags known to those skilled in the art. The bag 10 may be formed in any suitable size, shape and configuration and material known to those skilled in the art.

The device 5 may also include a pouch 12 for containing the bag 10. The pouch 12 may be sealed in a substantially air tight manner to maintain the freshness of the infusible substance. The pouch 12 may be substantially opaque such that the bag 10 may not be visible through the pouch 12. Accordingly, it will be understood that the depiction of FIG. 1 is for illustrative purposes since the bag 10 may not be visible through the pouch 12 as shown. However, it will be understood that some embodiments of the pouch 12 may be transparent such that the bag 10 may be visible through the pouch 12 as shown in FIG. 1.

A cord 14 may be attached to the bag 10 in a manner known to those skilled in the art to facilitate manipulating the bag 10. For example, the cord 14 may be used to place the bag in a fluid and to remove the bag 10 from the fluid. It will be understood that the cord 14 may be formed of a flexible member of any suitable material and configuration known in the art. For example, one embodiment of the cord 14 may be formed as a string. One embodiment of the cord may not be attached to the pouch 12, and may have a length that may be up to several times the length of the bag 10.

A tab 15 may be provided on an end of the cord 14 opposite the bag 10. The tab 15 may facilitate grasping the cord 14. Moreover, the tab may be folded to form a hook to keep the tab 15 and cord 14 in a desired position, as discussed more fully below.

It will be understood that the bag 10, the cord 14 and tab 15 may be substantially completely sealed inside the pouch 12. As shown in FIG. 2, accessing the bag 10, the cord 14 and the tab 15, in one embodiment of the disclosure, may involve opening the pouch 12 by removing or tearing an upper portion 18 and a lower portion 20 of the pouch 12. Accordingly, side portions 22 of the pouch 12 may remain substantially sealed. Alternative embodiments may involve opening only either the upper portion 18 or the lower portion 20, or opening one or both the side portions 22. One embodiment of the pouch 12 may include perforations to facilitate removing the upper portion 18 and the lower portion 20, or any other desired portion.

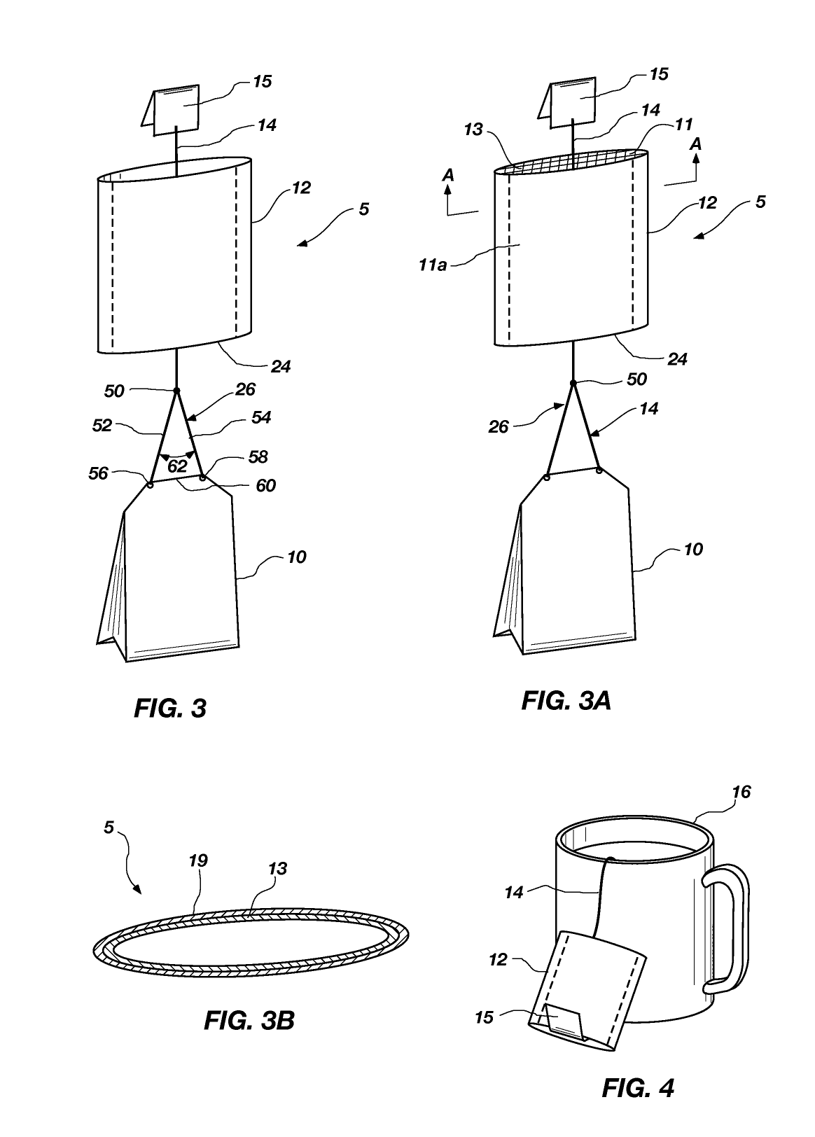

As shown in FIG. 3, once the upper portion 18 and the lower portion 20 have been removed or the pouch 12 is otherwise opened, the pouch 12 may form a sleeve for receiving the cord 14 and bag 10 therethrough. The bag 10 may be released to extend below the pouch 12 and the cord 14 may extend through the top of the pouch 12. Accordingly, one embodiment of the disclosure may allow the cord 14 to be accessible without threading the cord 14 through a small opening in the pouch 12 during the manufacturing process or afterwards. The cord 14 may include a bifurcation 26 at bifurcation point 50, which separated the cord 14 into segments 52 and 54, at an angle 62, such that the cord 14 is attached to an uppermost portion 60 of the bag 10 at two points, namely attachment points 56 and 58. The bifurcation 26 may form a tapered or triangular shape. The bifurcation 26 of the cord 14 at point 50 into segments 52 and 54 may serve to inhibit the bag 10 from rotating freely below the pouch 12. In addition, the segments 52 and 54 of the cord 14 may serve as a guide to direct the bag 10 into the pouch 12 as will be explained hereinafter.

Referring to FIG. 4, the bag 10 may be placed in a container 16 of liquid, such as a cup of water, in a manner known in the art to allow the infusible substance to contact the liquid and disperse in the liquid. The cord 14 may extend on the outside of the container 16 to allow the bag 10 to be withdrawn from the container 16 when desired. The pouch 12 and cord 14 may drape over the outside edge of the container 16 and remain dry. In one embodiment of the disclosure, the tab 15 may be folded to hook on the pouch 12 to prevent the pouch 12 from separating from the cord 14, or to prevent the cord 14 from being pulled into the pouch 12.

It will be understood that after the infusible substance has been exposed to the liquid in the container 16 for a suitable amount of time for the infusion process to take place (for the tea to brew, for example), the tab 15 or cord 14 may be grasped to lift the bag 10 out of the liquid. The bag 10 may be lifted into the pouch 12 and the pouch 12 may be pressed or squeezed with the bag 10 inside the pouch 12 to press excess fluid out of the bag 10. For example, a user may draw the bag 10 up inside the pouch 12 by holding the pouch 12 in one hand and pulling up on the cord 14 with the other hand.

The user may hold the bag 10 and pouch 12 over the container 16 and press on an exterior of the pouch 12 with the bag 10 pulled inside the pouch 12 to compress the bag 10 and force excess fluid out of the bag 10 and the bottom of the pouch 12 back into the container 16. Since the pouch 12 may be formed of a substantially impermeable material, the pouch 12 may prevent the user from contacting the liquid. Moreover, dripping of excess fluid from the bag 10 may be prevented, and additional flavor or material from the bag 10 may be deposited in the container 16. The pouch 12 may be discarded with the bag 10 still inside to further allow for a clean procedure.

In an embodiment of the disclosure illustrated in FIGS. 3A and 3B, the pouch 12 may comprise an insulation coating or material 13. The pouch 12 may comprise an inner surface 11 and an outer surface 11a. The inner surface 11 of the pouch 12 may comprise the insulation coating or material 13. The insulation coating or material 13 may operate as a thermal barrier between the pouch 12 and a user's hand to protect a user's fingers from hot fluid, such as hot water, that may be present when the bag 10 is lifted into the pouch 12 and the pouch 12 is pressed or squeezed with the bag 10 inside the pouch 12 to press excess fluid out of the bag 10. Various insulative coatings or materials may be used as the insulation coating or material 13 without departing from the spirit or scope of the disclosure. For example, any insulating material with insulating properties can be used such as plastics, polymers, ceramics, glass, silicon, paper, cardboard in addition to a thermal multi-layer insulation (MLI). For example, the MLI may be made of a plurality of very thin layers of a material such as Mylar or Kapton. The insulation coating or material 13 of the pouch 12 may be made from a heat insulation material that is relatively inexpensive such that the end product is relatively inexpensive to make and produce. The pouch may be the end product that can be used in conjunction with any third party manufacturer of an infusible substance, such as a tea product sold in a bag, or the end product may be the pouch being used as part of the infusible substance.

In an embodiment of the disclosure, the pouch 12 itself may be manufactured from an insulation material. The insulation material may operate as a thermal barrier between the pouch 12 and a user's hand to protect a user's fingers from hot fluid, such as hot water, that may be present when the bag is lifted into the pouch and the pouch is pressed or squeezed with the bag inside the pouch to press excess fluid out of the bag. Various insulative materials may be used as the insulation material without departing from the spirit or scope of the disclosure. For example, any insulating material with insulating properties can be used such as plastics, polymers, ceramics, glass, silicon, paper, cardboard in addition to a thermal multi-layer insulation (MLI). For example, the MLI may be made of a plurality of very thin layers of a material such as Mylar or Kapton. The pouch 12 may be made from a heat insulation material that is relatively inexpensive such that the end product is relatively inexpensive to make and produce. The pouch may be the end product that can be used in conjunction with any third party manufacturer of an infusible substance, such as a tea product sold in a bag, or the end product may be the pouch being used as part of the infusible substance.

In an embodiment of the present disclosure, the insulating material 13 may be a separate layer from the pouch 12. The insulating material 13 may be applied to an inner surface of a layer 19 of the pouch 12. For example, the outermost layer 19 may be comprised of a paper-based material, plastic, cellulose, or some other material. The insulating material 13 may be applied to an inner surface of the layer 19 as a spray-on material, by adhesive, or in some other manner. In an embodiment of the present disclosure, the insulating material 13 is inserted inside of the pouch 12 as a sleeve.

One aspect of the disclosure may include the cord 14 joined to the bag 10 in a plurality of locations. Accordingly, as the bag 10 is drawn into the pouch 12, the cord 14 may contact the pouch 12 in a plurality of locations, which may cause the bag 10 to enter into a better alignment with a bottom opening 24 of the pouch 12, to thereby facilitate drawing the bag 10 into the pouch 12. It will be understood that where the cord 14 has a single strand in contact with the pouch 12, the bag 10 may be allowed to rotate freely with respect to the pouch 12. However, one embodiment of the cord 14 may have a bifurcation 26 such that different portions of the cord 14 become separated at an increasing distance toward the bag 10 to form a tapered or triangular or wedge shape. This tapered configuration of the cord 14 may facilitate drawing the bag 10 into the pouch 12 as an upper portion of the bifurcation 26 may easily enter the pouch 12, and as the bifurcation 26 is drawn into the pouch 12, the bag 10 may automatically become aligned with the opening 24 due to contact of cord 14 at the bifurcation 26 with the pouch 12. It will be understood that the bifurcation 26 in the cord 14 may be formed of two or more strands of equal or different sizes, as compared to the remainder of the cord 14. Accordingly, the principles of the disclosure may be used to facilitate drawing the bag 10 into the pouch 12 without requiring the side portions 22 of the pouch 12 to be opened.

It will be understood that the bifurcation 26 in the cord 14 may start at any suitable location along the length of the cord 14. Moreover, the cord 14 may be attached to the bag 10 at any suitable location to create a desired configuration of the cord 14 to guide the bag 10 into the pouch 12.

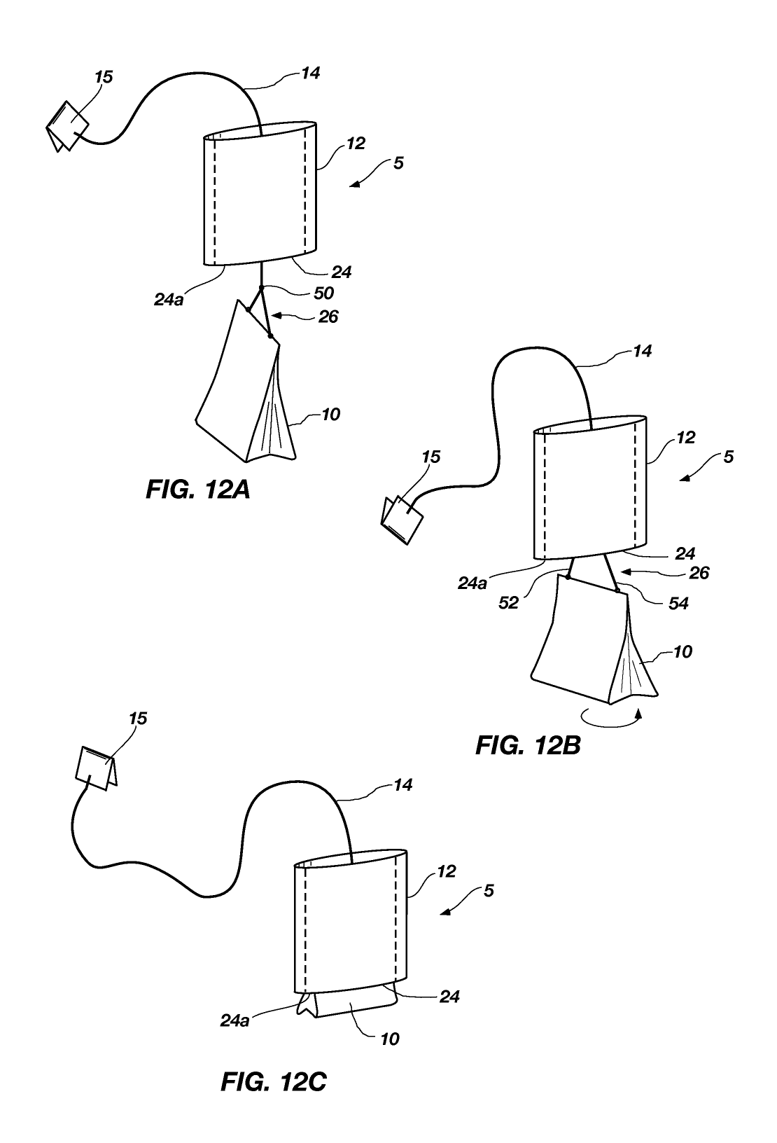

Referring now to FIGS. 12A, 12B, and 12C, the manner in which the bifurcation 26 of the cord 14 serves as a guide to facilitate withdrawal of the bag 10 into the pouch 12 will now be explained. FIG. 12A depicts the device 5 immediately after the bag 10 has been removed from a container having hot liquid. As can be observed, in FIG. 12A, the bag 10 is misaligned with the opening 24 at the bottom of the pouch 12. It will be appreciated that the opening 24 may be defined by at least one edge 24a of the pouch 12. In an embodiment of the present disclosure, the opening 24 may be defined by two edges of the pouch. As can be observed in FIG. 12B, as the tab 15 is pulled away from the pouch 12 and the cord 14 is tensioned, the segments 52 and 54 of the bifurcated portion 26 of the cord 14 engage the at least one edge 24a of the pouch 12 that form the opening 24. As the tension increased in the cord 14 is further increased, the bifurcated portion 26 causes the bag 10 to begin rotating until the bag 10 is automatically aligned with the opening 24 in the pouch 12. As can be observed in FIG. 12C, with the bag 10 properly aligned, the bag 10 can be easily withdrawn into the opening 24 in the pouch 12.

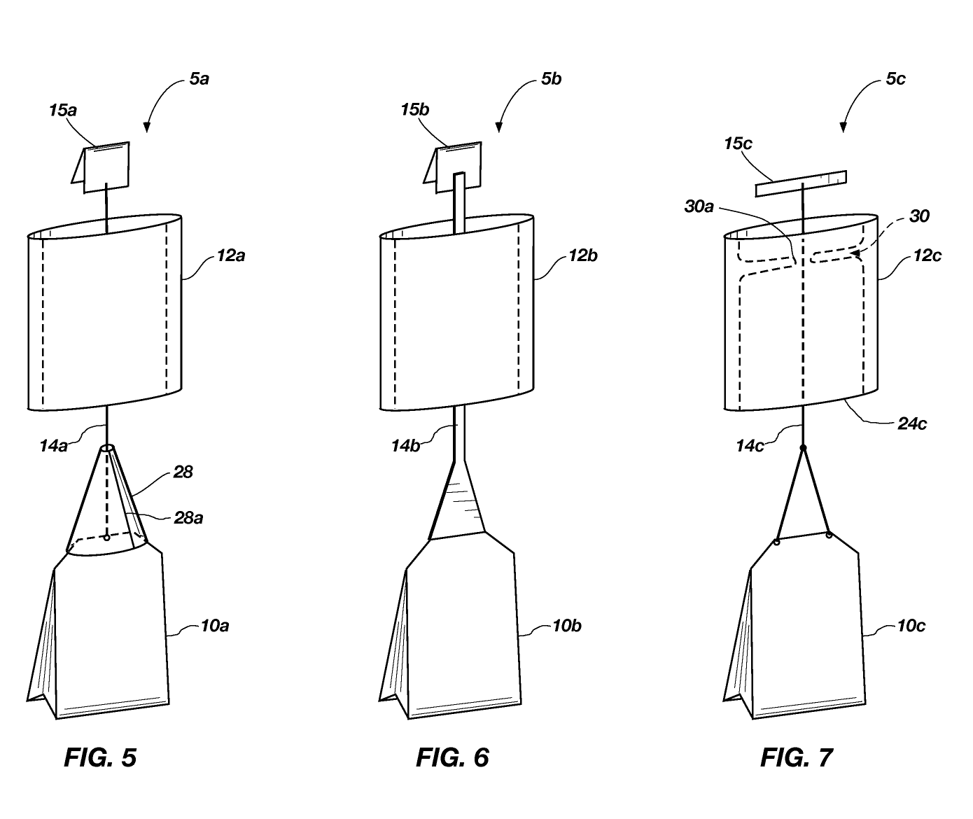

Referring now to FIG. 5, an alternative embodiment dispensing device is shown, indicated generally at 5a. As previously discussed, the presently preferred embodiments of the disclosure illustrated herein are merely exemplary of the possible embodiments of the disclosure, including that illustrated in FIG. 5.

It will be appreciated that the embodiments of the disclosure illustrated in FIGS. 5-11 may contain many of the same structures represented in FIGS. 1-4. New or different structures will be explained to most succinctly describe the additional advantages that come with the embodiments of the disclosure illustrated in FIGS. 5-11.

FIG. 5 depicts a perspective view of a device 5a having a cover 28 positioned over a cord 14a. The cover 28 may be formed of paper or plastic or any other suitable material. The cover 28 may be fixed or moveable with respect to the cord 14a. It will be understood that the cover 28 may have a tapered configuration to guide the bag 10a into the pouch 12a in a manner similar to the bifurcation 26 in the cord 14 as previously discussed in relation to FIGS. 12A-12C. Accordingly, the cord 14a may have a single strand attached to the bag 10a at a single location. Advantageously, the cover 28 may include a slit 28a such that it may be installed onto cord 14a. Alternatively, the cover 28 may be slipped over tab 15a and installed onto the cord 14a. The cover 28 may be used with a bifurcated cord with two or more points of attachment with a tea bag. The bifurcated cord may provide internal support to the cover 28. For example, the cover 28 may be used in conjunction with cord 14 as shown in FIGS. 3 and 3A. The segments 52 and 54 may be operable to provide a support structure for the cover 28.

FIG. 6 depicts a dispenser device 5b, a cord 14b that may be formed of a flat strip having a tapered shape to facilitate drawing the bag 10b into the pouch 12b in proper alignment in a manner similar to the bifurcation 26 in the cord 14 as previously discussed in relation to FIGS. 12A-12C. It will be understood that the cord 14b may be formed of any suitable material, such as paper or plastic, in any suitable configuration within the scope of the disclosure.

Referring now to FIG. 7, an embodiment of the dispensing device is shown, indicated generally at 5c. The device 5c may include a pouch 12c having a seal shape 30. The alternative seal shape 30 may be configured to direct the flow of liquid out the bottom 24c. Moreover, the alternative seal shape 30 may be configured to prevent the tab 15c or bag 10c from passing through the pouch 12c. In particular, the seal shape 30 includes a neck 30a for passing the cord 14c out of the top of the pouch 12c. The neck 30a is to small for the bag 10c to be passed through such that the bag 10c cannot be pulled out of the top of the pouch 12c. It will be understood that various other different seal configurations may be used within the principles of the disclosure.

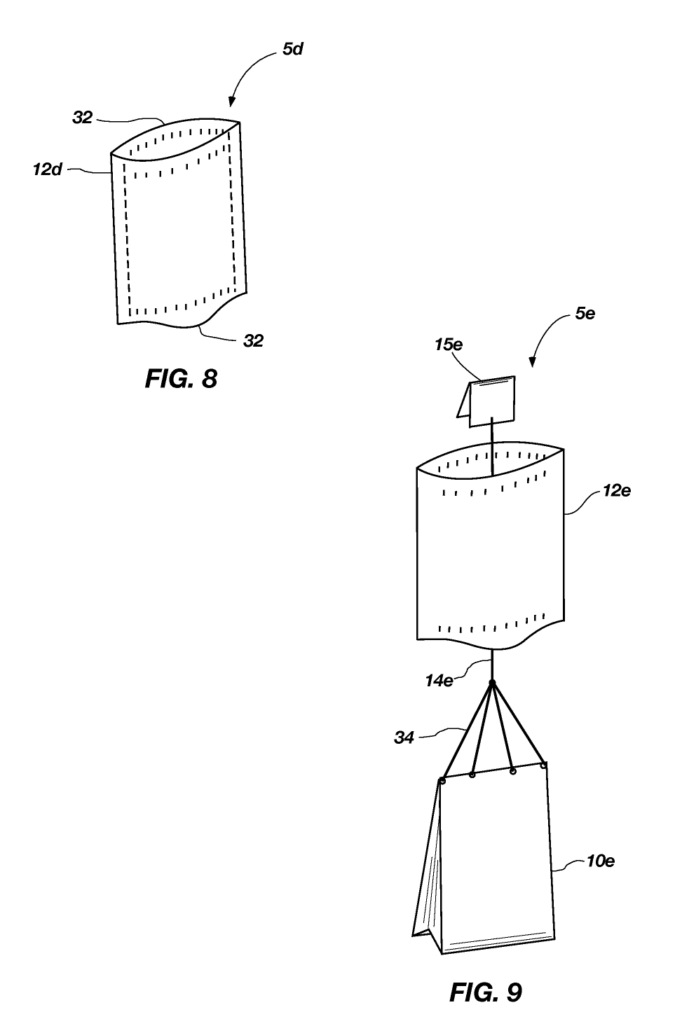

Referring now to FIG. 8, one embodiment of a dispenser device is shown, indicated generally at 5d. The device 5d may include a pouch 12d having flaps 32 that may be pulled to open the seal in the pouch 12d. The flaps 32 may be formed in any suitable configuration to allow a portion of the pouch 12d to be grasped to open the pouch 12d. It will be understood that an embodiment may have the flaps 32 located on different sides or locations of the pouch 12d, and other embodiments may have different quantities of flaps 32, or the flaps 32 may be used in combination with portions that may be torn to be removed from the pouch.

Referring now to FIG. 9, one embodiment of a dispensing device 5e is shown. The device 5e may have a cord 14e comprising a plurality of strands 34, such as four strands 34. The strands 34 may be attached to the bag 10e in any suitable configuration. It will be understood that any quantity of strands 34 may be used within the principles of the disclosure.

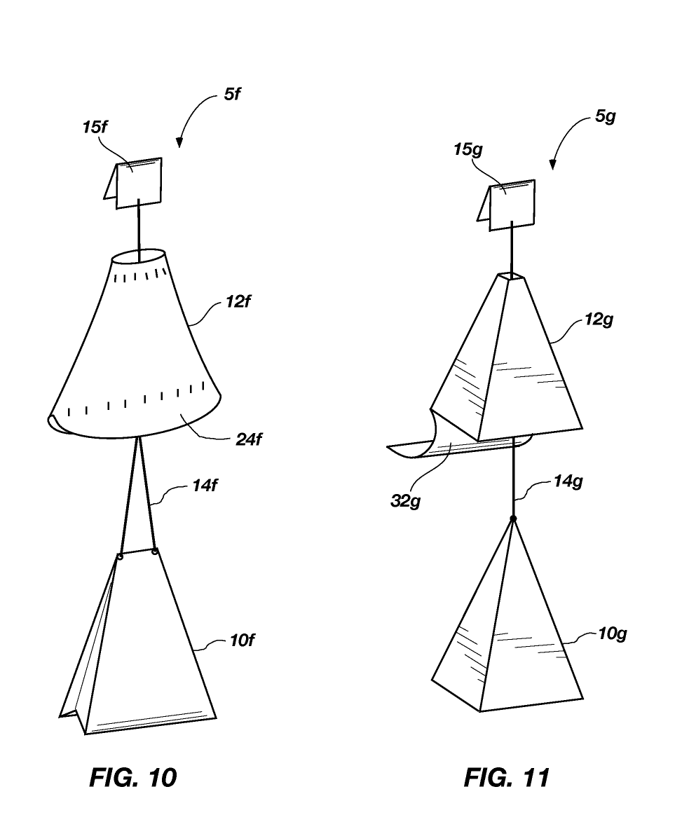

As shown in FIG. 10, which depicts yet another alternative embodiment dispensing device 5f, the pouch 12f and bag 10f may be formed in any suitable size, shape, or configuration. For example, the pouch 12f may include a tapered configuration, increasing in width from top to bottom such that the bottom 24f may be larger than the top. This may facilitate drawing the bag 10f into the pouch 12f. The bag 10f may have a corresponding tapered shape, or alternatively, the bag may have a different shape, for example, a cone or a disk, within the scope of the disclosure.

Similarly, as shown in FIG. 11, which shows one embodiment of a dispensing device 5g, the pouch 12g may have a substantial pyramid shape and the bag 10g may have a corresponding shape. One embodiment of the pouch 12g may have a flap 32g that may be peeled off to open the pouch 12g. It will be understood that the device 5g may be formed in various other configurations within the scope of the disclosure.

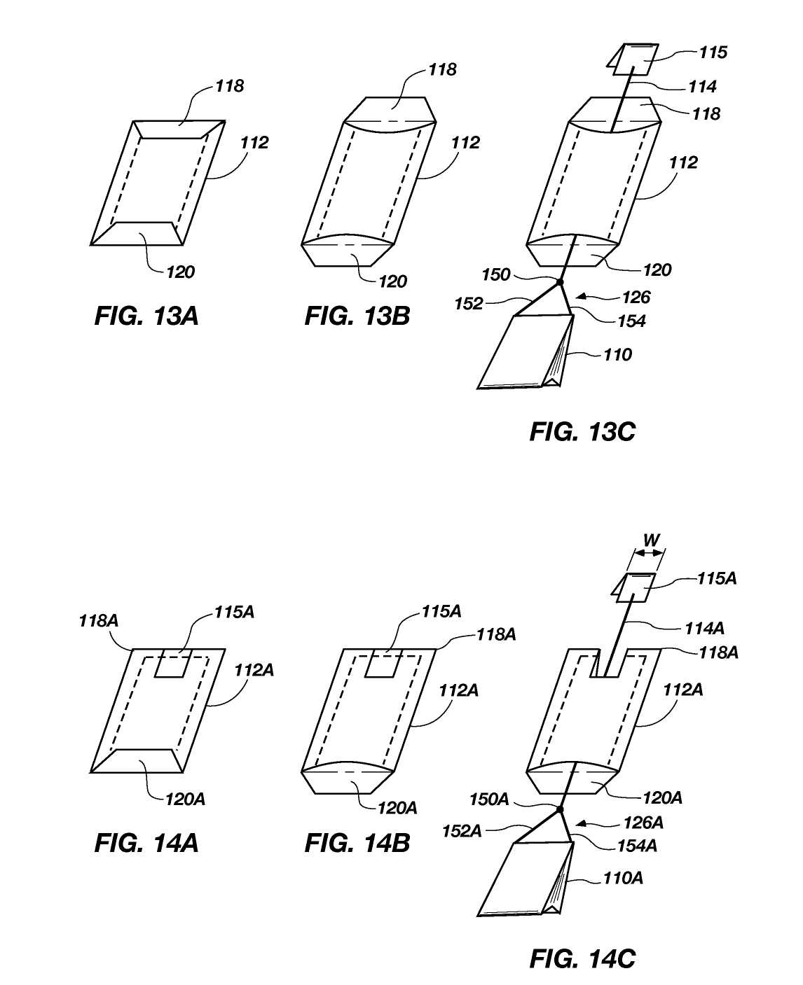

Referring now to FIGS. 13A, 13B, and 13C, an alternative embodiment of a device for dispensing an infusible substance, including a pouch with ends that are not sealed, and a bag, will be noted. The pouch 112, rather than including upper portion upper portion 18 and lower portion 20 (shown in FIG. 3), instead has unsealed upper portion 118 and unsealed lower portion 120. Similarly to other embodiments, the pouch 112 may form a sleeve for receiving the cord 114 and bag 110 therethrough. The bag 110 may be released to extend below the pouch 112 and the cord 114 may extend through the top of the pouch 112. Accordingly, one embodiment of the disclosure may allow the cord 114 to be accessible without threading the cord 114 through a small opening in the pouch 112 during the manufacturing process or afterwards. The cord 114 may include a bifurcation 126 at bifurcation point 150, which separates the cord 114 into segments 152 and 154. Accordingly, it is noted as to the pouch of the present disclosure, that in this embodiment the pouch being 112, need not be sealed, even though other embodiments involve a sealed pouch 12.

Referring now to FIGS. 14A, 14B, and 14C, another alternative embodiment of a device for dispensing an infusible substance, including a pouch having a tear-out portion 115A, a bag 110A, will be noted. The pouch 112A, rather than including upper portion upper portion 18 and lower portion 20 (shown in FIG. 3), instead has a sealed upper end 118A and an unsealed lower portion 120A. Similarly to other embodiments, the pouch 112A may form a sleeve for receiving the cord 114A and bag 110A therethrough. The bag 110A may be released to extend below the pouch 112A and the cord 114A may extend through the top of the pouch 112A. Accordingly, one embodiment of the disclosure may allow the cord 114A to be accessible without threading the cord 114A through a small opening in the pouch 112A during the manufacturing process or afterwards. The cord 114A may include a bifurcation 126A at bifurcation point 150A, which separates the cord 114A into segments 152A and 154A. Accordingly, it is noted as to the pouch of the present disclosure, that the pouch in this embodiment being 112A, need not be sealed at lower end 120A, even though other embodiments involve a sealed pouch 12, but that the upper portion 118A may be sealed, but include a tear-out portion 115A having a width W that is less than half of an average width of the pouch 112A, and width W may further be with a range of ten to twenty percent of an average width of the pouch 112A, between ten and fifty percent of an average width of the pouch 112A, or anywhere in between. Once the tear-out portion 115A is torn from or otherwise separated from the pouch 112A by a user, the upper end 118A is then no longer fully sealed.

The embodiments of FIGS. 13A-C, and FIGS. 14A-C, other than the differences they have with each other and the other embodiments of the present disclosure, may be operated in the same or very similar way.

It will be understood that the components of the disclosure may be formed of any suitable material using any known manufacturing technique within the scope of the disclosure. For example, the device 5 may be manufactured using a form fill and seal technique known in the art.

It will be appreciated that the structure and apparatus disclosed herein is merely one example of a means for performing a specified function. It should be appreciated that any structure, apparatus or system for performing the function that performs functions the same as, or equivalent to, those disclosed herein are intended to fall within the scope of a means for performing the function, including those structures, apparatus or systems for performing the function that are presently known, or that may become available in the future. Anything that functions the same as, or equivalently to, a means for performing the function falls within the scope of this element.

In accordance with the features and combinations described above, a useful method of making an infusible substance includes:

placing the infusible substance in a bag;

joining a cord with the bag;

sealing the bag and the cord in a pouch, such that the pouch is used insert the bag therein and to squeeze said bag after said bag is removed from a liquid to force the liquid out of said bag.

In accordance with the features and combinations described above, a useful method of for dispensing an infusible substance includes:

providing an infusible substance in a bag, wherein a cord is joined to the bag such that the bag and cord are sealed in a pouch;

opening an upper portion and a lower portion of the pouch to access the cord and allow the bag to pass through the pouch;

passing the cord through the pouch such that the bag is located beneath the pouch and the cord extends out the upper portion of the pouch;

placing the bag in a liquid;

withdrawing the bag from the liquid and pulling the bag into the pouch with the cord;

squeezing the pouch with the bag inside to force liquid out of the bag.

Those having ordinary skill in the relevant art will appreciate the advantages provide by the features of the disclosure. For example, it is a feature of the disclosure to provide a device for dispensing an infusible substance that is simple in design, manufacture, and operation. Another feature of the disclosure is to provide such a dispensing device that is relatively inexpensive to make and manufacture. Another feature of the disclosure is to provide such a dispensing device that can be used to improve cleanliness of the dispensing procedure. It is a further feature of the disclosure, in accordance with one aspect thereof, to provide a dispensing device that allows excess fluid to be removed from the device. Another feature of the disclosure is to provide a dispensing device that is insulated. The disclosure may be directed to an apparatus and method for dispensing an infusible substance (such as tea) in a liquid from a porous bag and then discharging excess liquid from the bag. The bag may be drawn up and contained inside a pouch and liquid may be squeezed out of the bag. The pouch can then be handled without touching any wet portion of the bag. The pouch can also be placed on a surface, substantially protecting the surface from exposure to any residual liquid still contained in the bag.

In the foregoing Detailed Description, various features of the disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A device for dispensing an infusible substance, said device comprising:
a bag for receiving the infusible substance; and
a cord attached to said bag;
wherein said bag and said cord are sealed within a pouch such that said bag and said cord are accessed by opening an upper portion and a lower portion of said pouch such that said pouch forms a sleeve for receiving said cord and said bag therethrough.

2. The device of claim 1, further comprising a tab joined to said cord.

3. The device of claim 2, wherein said tab comprises a fold for contacting said pouch to maintain said pouch on said cord.

4. The device of claim 1, wherein said cord is attached to said bag at a plurality of locations such that said cord contacts said pouch to guide said bag into said pouch.

5. The device of claim 1, wherein said pouch comprises perforations to facilitate removing said upper portion and said lower portion to open said pouch.

6. The device of claim 1, wherein said cord is a string.

7. The device of claim 1, wherein said cord is a flat strip.

8. The device of claim 1, further comprising a cover for covering said cord.

9. The device of claim 8, wherein said cover comprises a tapered configuration such that said cover widens toward said bag.

10. The device of claim 1, wherein at least one of said upper portion and said lower portion of said pouch comprises a flap for peeling open said pouch.

11. The device of claim 1, wherein said cord comprises a plurality of strands attached to said bag at a plurality of locations.

12. The device of claim 1, wherein said pouch comprises a tapered configuration widening from said upper portion of said pouch to said lower portion of said pouch.

13. The device of claim 1, wherein said bag comprises a tapered configuration widening from an upper portion of said bag to a lower portion of said bag.

14. The device of claim 1, wherein said pouch comprises a substantially rectangular shape as viewed from the side.

15. The device of claim 1, wherein said pouch comprises a substantially pyramidal shape.

16. The device of claim 1, wherein said bag comprises a substantially pyramidal shape.

17. The device of claim 1, wherein said bag is permeable to fluid and said pouch is substantially impermeable to fluid.

18. A device for dispensing an infusible substance, said device comprising:
a bag for receiving an infusible substance;
a cord attached to said bag; and
a pouch for receiving said bag and said cord therein;
wherein said cord is attached to said bag at a plurality of locations to facilitate guiding said bag into said pouch.

19. A device for dispensing an infusible substance, said device comprising:
means for holding said infusible substance;
means for manipulating said means for holding; and
means for sealing said means for holding such that an upper and lower portion of said means for sealing may be opened to pass said means for holding through said means for sealing to dispense said infusible substance, and to draw said means for holding into said means for sealing to allow excess fluid to be pressed out of said means for holding.

20. A method for dispensing an infusible substance, said method comprising:
placing said infusible substance in a bag;
joining a cord with said bag;
sealing said bag and said cord in a pouch;
opening an upper portion and a lower portion of said pouch to access said cord and allow said bag to pass through said pouch;
passing said cord through said pouch such that said bag is located beneath said pouch and said cord extends out the upper portion of said pouch;
placing said bag in a liquid;
withdrawing said bag from said liquid and pulling said bag into said pouch with said cord;
squeezing said pouch with said bag inside to force liquid out of said bag.

21. A method for dispensing an infusible substance, said method comprising:
providing an infusible substance in a bag, wherein a cord is joined to the bag such that the bag and cord are substantially sealed in a pouch;
opening an upper portion and a lower portion of said pouch to access said cord and allow said bag to pass through said pouch;
passing said cord through said pouch such that said bag is located beneath said pouch and said cord extends out the upper portion of said pouch;
placing said bag in a liquid;
withdrawing said bag from said liquid and pulling said bag into said pouch with said cord;
squeezing said pouch with said bag inside to force liquid out of said bag.

22. A device for dispensing an infusible substance, said device comprising:
a pouch comprising a first opening and a second opening in communication with an inner area configured such that the inner area receives therein a bag with a draw member extending therefrom and with the infusible substance contained within the bag;
wherein the pouch forms a sleeve that is configured such that the draw member passes through the first opening and the second opening whereby said bag is positionable within the inner area of said pouch to enable a user to grasp said bag without making direct contact with said bag.

23. The device of claim 22, wherein the pouch comprises an insulative material.

24. The device of claim 23, wherein the insulative material is selected from a group consisting of a plastic, polymer, ceramic, glass, silicon, paper, cardboard and thermal multi-layer insulation.

25. The device of claim 22, wherein the pouch is lined with an insulative material.

26. The device of claim 25, wherein the insulative material is selected from a group consisting of a plastic, polymer, ceramic, glass, silicon, paper, cardboard or thermal multi-layer insulation.

27. The device of claim 1, wherein the pouch comprises an insulative material.

28. The device of claim 27, wherein the insulative material is selected from a group consisting of a plastic, polymer, ceramic, glass, silicon, paper, cardboard or thermal multi-layer insulation.

29. The device of claim 1, wherein the pouch is lined with an insulative material.

30. The device of claim 29, wherein the insulative material is selected from a group consisting of a plastic, polymer, ceramic, glass, silicon, paper, cardboard or thermal multi-layer insulation.

31. A device for dispensing an infusible substance, said device comprising:
a pouch having at least one edge defining an opening leading to an interior portion;
a bag for receiving the infusible substance;
a cord attached to said bag; and
said cord comprising a guiding means for engaging said at least one edge to thereby align said bag with the opening leading into the interior portion of said pouch when said cord is placed under tension.

32. The device of claim 31, further comprising an insulating material disposed on an inner surface of said pouch.

33. The device of claim 31, wherein said guiding means comprises a pair of cord segments each having a first end and a second end, wherein said first ends of the cord segments are attached to an uppermost portion of the bag at spatially offset locations and wherein said second ends of the cord segments are joined at a common bifurcation point such that said cord segments form a taper.

34. The device of claim 33, further comprising a cover disposed over said taper formed by said cord segments.

35. The device of claim 34, wherein said cover is removably installable onto said cord segments.

36. The device of claim 34, wherein said cover is structurally supported by said cord segments.

37. The device of claim 34, wherein said cover comprises at least one of a taper and a frustoconical shape.

38. The device of claim 34, wherein said cover comprises a slit for facilitating installation of said cover onto said cord.

39. The device of claim 31, wherein the pouch is lined with an insulative material.

40. The device of claim 39, wherein the insulative material is selected from a group consisting of a plastic, polymer, ceramic, glass, silicon, paper, cardboard or thermal multi-layer insulation.

41. The device of claim 31, wherein said at least one edge comprises a pair of edges.

42. The device of claim 31, wherein said guiding means comprises at least one of a tapered portion and a cover.

43. A device for dispensing an infusible substance, said device comprising:
a pouch having at least one edge defining an opening leading to an interior portion;
a bag for receiving the infusible substance;
a cord attached to said bag;
said cord comprising a guiding means for engaging said at least one edge to thereby align said bag with the opening leading into the interior portion of said pouch when said cord is placed under tension;
a tab joined to said cord; and
said pouch having an insulative layer disposed on an inner surface;
wherein said guiding means comprises a pair of cord segments each having a first end and a second end, wherein said first ends of the cord segments are attached to an uppermost portion of the bag at spatially offset locations and wherein said second ends of the cord segments are joined at a common bifurcation point such that said cord segments form a taper;
wherein said bag and said cord are sealable within the pouch such that said bag and said cord are accessed by opening an upper portion and a lower portion of said pouch such that said pouch forms a sleeve for receiving said cord and said bag therethrough.

44. The device of claim 43, further comprising a cover disposed over said taper formed by said cord segments, said cover comprising at least one of a taper and a frustoconical shape.
